(19) United States
(12) Patent Application Publication
(10) Pub. No.: US 2017/0034177 A1
(43) Pub. Date: Feb. 2, 2017

(54) SYSTEM AND METHOD FOR SHARING RESTRICTED CUSTOMER DATA WITH AN ENTERPRISE USER DURING CUSTOMER INTERACTION

(71) Applicant: salesforce.com, inc., San Francisco, CA (US)

(72) Inventors: Anand Bashyam Narasimhan, Voorhees, NJ (US); Sohail Sikora, Princeton, NJ (US); Mohammad Asif Ali Khan, San Jose, CA (US); Ramit Singh, Fremont, CA (US)

(73) Assignee: salesforce.com, inc., San Francisco, CA (US)

(21) Appl. No.: 14/813,562

(22) Filed: Jul. 30, 2015

(51) Int. Cl. H04L 29/06; G06Q 50/26

(52) U.S. Cl. CPC H04L 63/101; G06Q 50/265

(57) ABSTRACT

Computer-implemented methods and systems are provided for controlling access to restricted customer data (RCD) by a computer associated with a particular user of an enterprise while the particular user is interacting with a particular customer. The RCD is associated with the particular customer and stored in an enterprise database. An enterprise server (ES) monitors for an indication that the particular customer has sent a request to interact with a user of the enterprise. In response to receiving the indication at the ES, the ES can determine that the particular user accepted the request. The ES can then automatically modify the particular user's access privileges grant access to the RCD. When the ES receives another indication that interaction with the particular customer has ended, the ES can automatically revoke the particular user's access to the RCD.

### TECHNICAL FIELD

Embodiments of the subject matter described herein relate generally to computer implemented methods, computer systems and applications for allowing a user of an enterprise to interact with customers of that enterprise, and, more particularly, to methods, computer systems and applications for sharing restricted customer data with an enterprise user during customer interaction.

### BACKGROUND

Many enterprises now use cloud-based computing platforms that allow services and data to be accessed over the Internet (or via other networks). Infrastructure providers of these cloud-based computing platforms provide network-based processing systems that often support multiple enterprises (or tenants) using common computer hardware and data storage. This “cloud” computing model allows applications to be provided over the network “as a service” supplied by the infrastructure provider. The infrastructure provider typically abstracts the underlying hardware and other resources used to deliver a enterprise-developed application so that the enterprise no longer needs to operate and support dedicated server hardware. The cloud computing model can often provide substantial cost savings to the enterprise over the life of the application because the enterprise no longer needs to provide dedicated network infrastructure, electrical and temperature controls, physical security and other logistics in support of dedicated server hardware.

Multi-tenant cloud-based architectures have been developed to improve collaboration, integration, and community-based cooperation between enterprise tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

A particular tenant or enterprise (such as a retail bank) can have many customers and many users that access customer data associated with those customers. Within the enterprise it is important to restrict access to customer data because it is valuable, confidential or proprietary. For example, if access to customer data is unrestricted, any user within the organization can potentially take that customer data and use it for any purpose they desire including uses outside the enterprise. For instance, if the customer data has value to other parties, the user could sell the customer data to the parties at the potential detriment of the enterprise. One example would be in the context where the enterprise is an investment bank, and its customers are high net-worth individuals. If an employee of the investment bank, such as a call-center user, is given access to customer data they could inadvertently or intentionally allow customer data to be exposed outside the enterprise. At the same time, in order to provide acceptable service to a particular customer when interacting with that customer, it may be beneficial to allow the user to have access to customer data (e.g., to provide a high quality of service).

An enterprise (e.g., a bank) can maintain customer data (e.g., records) for each of its customers in a database, such as a multi-tenant database that is part of a cloud computing platform. An enterprise has a number of users (e.g., employees, users or agents, etc.) who may need to access customer data that is stored (e.g., as objects) in the enterprise's database. Access refers to a user's ability to open, view, interact with, edit (change, add, delete), manipulate, copy, create new, etc. Traditionally, each user's access is restricted based on that particular user's role, permissions, credentials, etc. As such, with respect to a particular user, access to some customer data can be blocked or “restricted,” meaning that a particular user does not have permission to access customer data (or only has permission to access some of the customer data). Stated differently, a particular user's access to certain objects maintained within the enterprise's database can be restricted based on a particular user's role, permissions, credentials, etc. When access to an object (or set of objects) is restricted for a particular user, then that particular user cannot access that particular object (or set of objects) unless access is granted by a network administrator of the enterprise (or the “owner” of the data).

For example, in one approach, to help protect customer data, an enterprise can employ a private security model such that only an owner of the customer data has access to customer data. Depending on the implementation, the owner can be a user who created the record for that customer, or an administrator of the enterprise. In this private security model, only the owner has access to the customer data for that particular customer. The owner may grant shared access to the customer data to other users or groups within the enterprise/organization (e.g., by defining sharing rules or manually granting access to allow other users or groups within the enterprise to access the customer data for that particular customer). The owner can also define the scope of access for a particular user or group. For instance, the owner may allow a particular user or group to have read-only access, read/write access, or may define sharing rules that give a particular user or members of a group permission to share that customer data with other users or groups within the enterprise.

However, in some cases it is desirable for certain users (e.g., employees, users, agents, contractors, etc.) to have access to customer data while interacting with a customer. For example, in some enterprises, one class or group of users are customer users such as call-center attendants that interact with customers. Normally, permission levels for customer users are set such that they have access to some customer data, but do not have access to other customer data. For example, a customer user may be permitted to access high-level customer data associated with a particular account, but their access to other more sensitive customer data is blocked or restricted. This is necessary for regulatory and security reasons, but can be undesirable in certain situations when access to that restricted information will help improve the user's interaction with the customer.

One option would be for the owner to manually grant the user access to the customer data, and to then manually terminate access to the customer data when the user indicates they are done interacting with the customer. However, manually granting each user shared access to customer data can be cumbersome, time consuming, error prone and risky. The same is true for manually terminating each user's shared access to that customer data.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 is a schematic block diagram of a multi-tenant computing environment in which the disclosed embodiments can be implemented;

FIG. 2 is a schematic block diagram of a computer-implemented system in accordance with an embodiment;

FIG. 3 is a flow chart illustrating an exemplary method for controlling access to restricted customer data in accordance with an embodiment;

FIG. 4 is a graphical metaphor illustrating an embodiment;

FIG. 5 illustrates a web page that can be displayed during interaction between a customer and a user in accordance with one exemplary implementation of an embodiment; and

FIG. 6 illustrates a web page that can be displayed when interaction between the customer and the user ends in accordance with one exemplary implementation of an embodiment.

### DETAILED DESCRIPTION

Systems and methods are thus needed for automatically sharing access to restricted customer data with certain computing devices of users within an enterprise network, but without increasing the risk of exposure of that restricted customer data outside the interaction with the customer. It would be desirable if such systems and methods can share customer data with certain users of an enterprise in real-time, on-demand.

Embodiments of the subject matter described herein generally relate to computer-implemented methods and systems for controlling access to restricted customer data by a particular user of an enterprise while the particular user is interacting with a particular customer. The restricted customer data is stored in an enterprise database and is associated with the particular customer. An enterprise server monitors for an indication that the particular customer has sent a request to interact with a user of the enterprise. In response to receiving an indication, the enterprise server can determine that the particular user is one of a plurality of users (within in the enterprise) that accepted the customer's request for interaction. The enterprise server can then automatically modify access privileges associated with the particular user to provide the particular user with access to the restricted customer data. When the enterprise server receives another indication that the particular user is no longer interacting with the particular customer, the server can automatically modify the access privileges associated with the particular user to revoke access to the restricted customer data by the particular user. Thus, restricted customer data, that is normally inaccessible by or unavailable to a particular user, can be automatically shared with that particular user while he/she is presently interacting with a particular customer, but only for the duration of the interaction between that particular user and the particular customer. Stated another way, the restricted customer data can be shared with the particular user for a limited time such that customer data for that particular customer is accessible by (or available to) the particular user only during the duration of the interaction between the particular user and the particular customer (e.g., so long as that particular user is interacting with the particular customer). When interaction with that particular customer ends, the particular user is no longer able to access that restricted customer data (e.g., the customer data or records are inaccessible to the user).

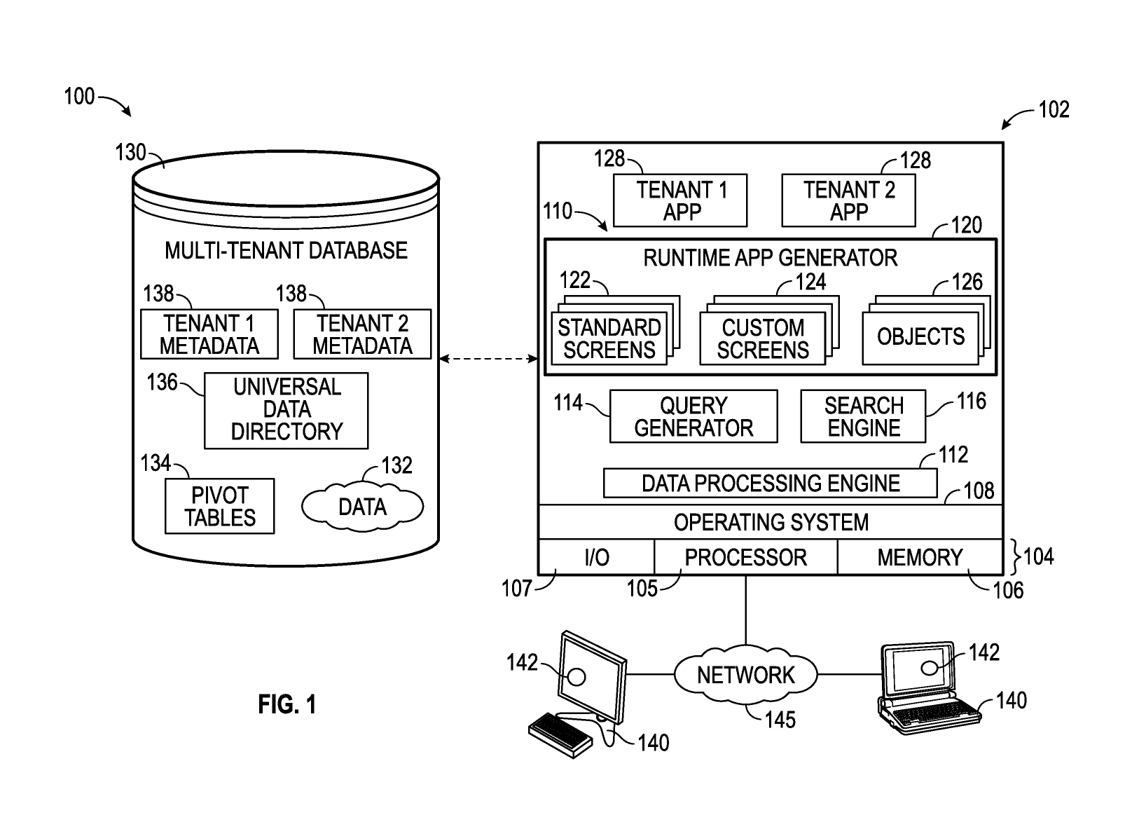

FIG. 1 is a schematic block diagram of a multi-tenant computing environment in which the disclosed embodiments can be implemented. Those skilled in the art will appreciate that the techniques and technologies described herein may be implemented in any platform or computing environment that includes a database that stores restricted customer data that is to be shared with an enterprise user (or “user of the enterprise”) only during their interaction with a customer of the enterprise.

This exemplary cloud based solution may be implemented in the context of a multi-tenant system 100 including a server 102 that supports applications 128 based upon data 132 from a database 130 that may be shared between multiple enterprises, tenants, or organizations, referred to herein as a multi-tenant database. Data and services generated by the various applications 128 are provided via a network 145 to any number of client devices 140, such as desktops, laptops, tablets, smartphones, Google Glass™, or other business or consumer electronic device or system, including web clients.

In an embodiment, each client device, application, or web client may be suitably configured to run a client application 142, such as the event-based sharing module or other application for performing similar functions, as described in greater detail below. As an alternative vector into the automatic event-based sharing may be implemented by an application protocol interface (API), either in lieu of or in addition to the client application 142. In this way, a developer may create custom applications/interfaces to drive the sharing of data and/or files (and receive updates) with the same collaboration benefits provided by the client application 142.

Each application 128 is suitably generated at run-time (or on-demand) using a common application platform 110 that securely provides access to the data 132 in the database 130 for each of the various tenant organizations subscribing to the service cloud 100. In accordance with one non-limiting example, the system 100 is implemented in the form of an on-demand multi-tenant customer relationship management (CRM) system that can support any number of authenticated users for a plurality of tenants.

As used herein, an “enterprise,” a “tenant” or an “organization” should be understood as referring to a group of one or more users (typically employees, representatives, agents, contractors of an enterprise) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Examples of enterprise tenants can include, but are not limited to, organizations, banks, insurance companies, health care organizations, law firms or legal departments, travel reservation systems, event ticketing and support systems such as stadiums, theaters. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

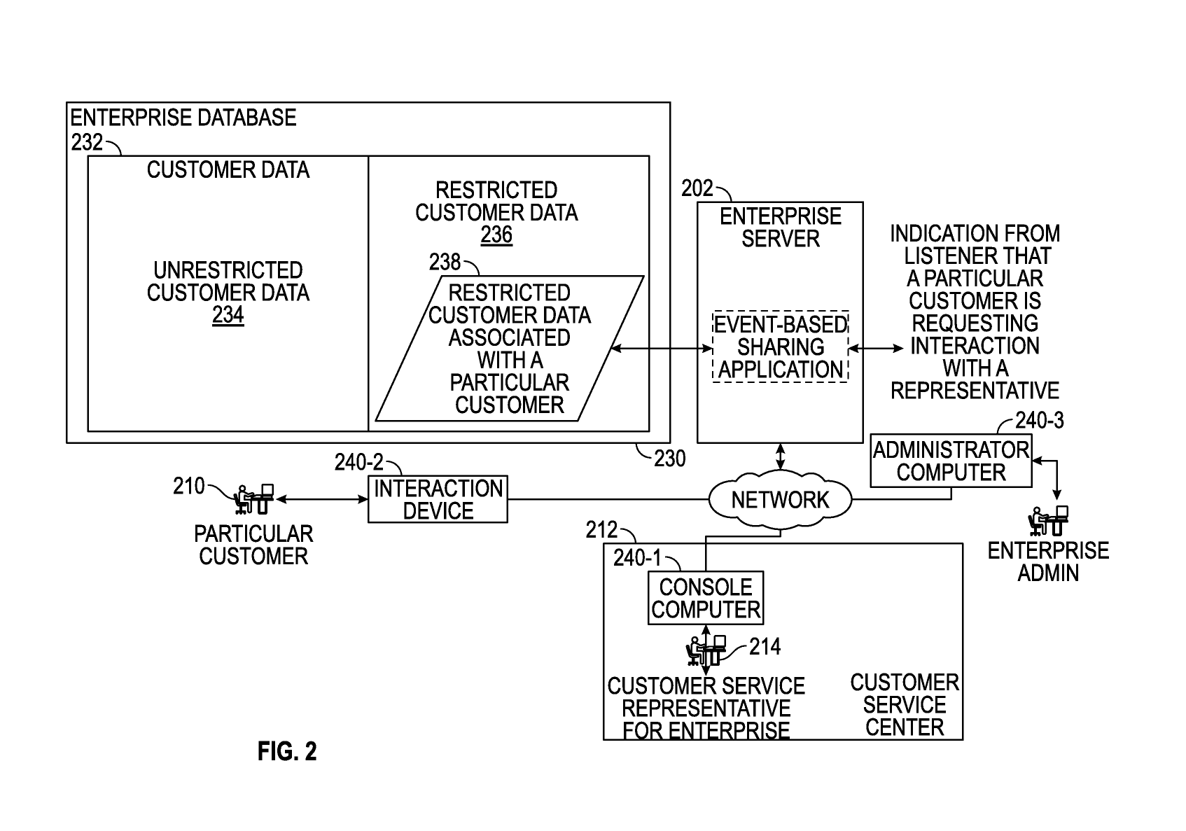

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc. In accordance with the disclosed embodiments, the data processing engine 112 can include an event-based sharing application (describe in detail below with reference to FIG. 2) that can change a data structure of the tenant metadata 138 to control the particular user's access to restricted customer data stored at the multi-tenant database 130. For example, the event-based sharing application can modify (e.g., add or remove) data within a data structure of the tenant metadata 138 to control the particular user's access to the restricted customer data stored at the multi-tenant database 130. For example, the event-based sharing application can add data to a data structure of the tenant metadata 138 to grant a particular user access privileges to access restricted customer data stored at the multi-tenant database 130. By contrast, the event-based sharing application can remove data from a data structure of the tenant metadata 138 to revoke the particular user's access privileges to access the restricted customer data stored at the multi-tenant database 130.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

The virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128.

As briefly mentioned above, in many cases it is desirable restrict access to some or all of the customer data so that users do not have access to restricted customer data. If a particular user wants to access restricted customer data, this typically requires that an administrator (or by the owner of that customer data) reconfigures that user's access privileges or other settings to allow the user to access that restricted customer data. This is inefficient and time consuming.

In accordance with various embodiments, application 128 includes the functionality of a Service Cloud system, as well as the functionality of Service Could console module that includes an event-based sharing application, as described in detail below. As such, application 128 is implemented at the server to facilitate user access to data objects (including those that are associated with customer data) between the cloud and various computing devices connected to the cloud, as described in detail below. Specifically, application 128 allows a user to automatically access to information (e.g., restricted customer data) about a particular customer locally on the desktop, laptop, tablet, hand held, or other mobile device so long as that particular user is interacting with a particular customer. The application 128 ensures the particular user's access to the restricted customer data only during interaction between the particular user and that particular customer, and automatically revokes/terminates the user's access when interaction between the particular user and that particular customer ends such that the particular user is no longer permitted to access that customer data (e.g., the customer data or records are inaccessible to the user). As such, the application 128 allows for restricted customer data to be shared with a particular user in real-time, on-demand so long as that particular user is interacting with a particular customer (e.g., only for the duration of the user's interaction with that particular customer) to help reduce the chances of data loss, a breach of confidentiality, etc.

FIG. 2 is a schematic block diagram of a computer-implemented system in accordance with an embodiment. The computer-implemented system 200 includes an enterprise server 202, an enterprise database 230, a computer 240-1 that is associated with a particular user 214 of the enterprise who is part of a customer service center 212 for that enterprise, an interaction device 240-2 associated with a particular customer 210 of the enterprise, and a network 245. In one non-limiting implementation, the enterprise server 202 can be implemented as described above with reference to server 102, and the enterprise database 230 can be implemented as described above with reference to database 130. The network 245 can include any of the features associated with network 145 (FIG. 1) and provides the computer 240-1 and the interaction device 240-2 with network access. For example, the network 245 allows the computer 240-1 to communicate with the enterprise server 202 and the enterprise database 230.

As used herein, a customer refers to any person or entity that has provided the enterprise with data about that customer. Examples of customers can include clients, investors, patients, any consumers of the product or service sold by the enterprise, etc. As used herein, a user can be any user associated with the enterprise (e.g., an employee, representative, agent, contractor, or any other party who has been authorized or granted access to the enterprise server, etc.). It should be appreciated that an enterprise can include many additional customers and many additional users (not illustrated in FIG. 2 but that are also part of the customer service center 212). The users can interact with customers of the enterprise via additional computers that are communicatively coupled to the enterprise server 202, and to other interaction devices of many other customers. For sake of clarity, these “other” computers and interaction devices are not illustrated. Nevertheless it will be appreciated that multiple users can be logged into the enterprise server 202 at any given time. Although there are many customers and users that are associated with an enterprise, the following description designates a particular customer 210 and a particular user 214 that has accepted the particular customer's request to interact.

Further, in the following descriptions for FIGS. 2-5, certain tasks, acts, or events will be described with reference to a particular user 214/414 and a particular customer 210/410. However, it should be appreciated that those descriptions may refer to tasks, acts, or events that actually take place at or in conjunction with a computer 240-1 of the particular user 214/414 and at or in conjunction with interaction device 240-2 of the particular customer 210/410. As such, depending on the context, any such descriptions tasks, acts, or events that are described with reference to the particular user 214/414 and the particular customer 210/410 may be interpreted tasks, acts, or events that actually take place at or in conjunction with a computer 240-1 of the particular user 214/414 and at or in conjunction with interaction device 240-2 of the particular customer 210/410. As an example, a description that “a particular user 214 accepts or answers the request to interact with that particular customer 210,” can be interpreted as meaning that “a computer 240-1 of the particular user 214 accepts or answers the request to interact with the interaction device 240-2 of that particular customer 210.” As another example, a description that the enterprise server 202 “automatically modifies access privileges associated with the particular user 214 to temporarily provide the particular user 214 with access to the restricted customer data 238,” can be interpreted as meaning that the enterprise server 202 “automatically modifies access privileges associated with the computer 240-1 of the particular user 214 to temporarily provide the computer 240-1 of the particular user 214 with access to the restricted customer data 238.”

As will be described in greater detail below, computer-implemented system 200 can be used to control access to restricted customer data 238 by the computer 240-1 of the particular user 214 of an enterprise while the particular user 214 is interacting with a particular customer 210 of that enterprise.

Customer Data

The enterprise database 230 stores data of the enterprise including customer data 232 for a plurality of different customers. One of the customers is referred to as a particular customer herein to illustrate one possible operation scenario with respect to that particular customer. The customer data 232 can be stored in a computer memory of the enterprise database 230 as data structures, objects or any other generic container that can be used to store information regarding records that relate to the particular customer 210. In a logical sense the customer data 232 can be classified as either customer data 234 that is unrestricted or customer data 236 that is restricted with respect to that particular user 214. Customer data 234 that is unrestricted can be accessed by any user of the enterprise that is authorized to access the server. By contrast, customer data 236 that is restricted is generally inaccessible by users unless the user has been granted access privileges by an enterprise administrator 216 or owner of the data.

For each customer of the enterprise, certain customer data is unrestricted or restricted. In FIG. 2, data block 238 represents restricted customer data 238 that is associated with a particular customer 210. The restricted customer data 238 includes information about the particular customer 210 that the enterprise has obtained and stored at the database 230. For example, restricted customer data 238 can include sensitive information that the enterprise deems as confidential or valuable. Examples of restricted customer data 238 can include, for example, information such as personal information about the customer, confidential or proprietary information about the customer, transaction information regarding transactions with the customer, sales information regarding sales with the customer, financial information, or any other information about the enterprise's interaction with the customer that could potentially be deemed sensitive.

The enterprise server 202 is communicatively coupled to the computer 240-1 of the particular user 214 (that is part of a customer service center), the interaction device 240-2 of the particular customer 210, and the enterprise database 230.

The user 214 can open a web browser on computer 240-1, and login or otherwise connect to a dedicated web portal, which may include customer relationship management (CRM) tools such as those available from Salesforce.com. Once the user is logged into the enterprise server 202, the user 214 can use a web-based user interface interact with the database 230 via the server 202. The user 214 can use the web-based user interface to access any data stored in the enterprise database 230 that the user has been granted access privileges to access (i.e., if access is granted at the enterprise server 202).

The interaction device 240-2 can be any communication device (e.g., landline-based or internet-based telephone, cellular phone, smartphone, laptop computer, desktop computer, tablet computer, or any other computing device that is part of a customer service center 212, etc.) that allows a customer to interact with a user of the enterprise (e.g., communicate information to each other and/or receive information from each other over the network 245, or other communication networks that are not illustrated in FIG. 2).

Customer Request for Interaction with User

The particular customer 210 can use the interaction device 240-2 to input information to request interaction with a user of the enterprise, and other identifier information that identifies the particular customer 210 to any user that receives the request from the particular customer 210.

In one embodiment, the particular customer 210 can input information via a user interface of an interaction device 240-2 to request interaction with a user of the enterprise and/or to generate a request for interaction with a user of the enterprise. For example, in one embodiment, the particular customer 210 can input information using their voice (e.g., by communicating with the user or via a voice command), by selecting button(s) or a link or other user interface element, or any other type of user input by the particular customer 210).

In one implementation, the particular customer 210 can input information to request interaction along with identifier information that identifies that particular customer (e.g., a name, e-mail address, account number, security code, password, pin, social security number, voice input, and/or other identifying indicia such as geo-location, phone numbers, social media handles). The request can include the identifier information that identifies the particular customer 210.

The enterprise server 202 can use the identifier information to determine which user has started to interact with the particular customer 210 (and that is currently interacting with the particular customer 210). The identifier information can also be used at the enterprise server 202 to determine which customer data the access privileges need to be changed for during the interaction. In other words, once the enterprise server 202 determines which particular user 214 is interacting with the particular customer 210, the enterprise server 202 can modify access privileges to permit the particular user 214 to access any customer data (including restricted customer data 238) that would otherwise be inaccessible to the particular user 214. The particular user's 214 acceptance of the particular customer's request for interaction can be in the context of a secure session with the particular customer 210 which uniquely identifies the particular user 214.

Types of Interaction Requested

In one embodiment, the interaction requested by the particular customer 210 can be a request for a communication session between the particular user 214 and the particular customer 210. The type of communication session requested can also vary depending on the implementation and can include communication sessions such as a telephone call, a web-based chat or messaging session, an e-mail conversation or communication session, a text messaging session, social media interaction, or any other type of communication session between the particular customer 210 and the particular user 214.

For example, in one embodiment, the communication session can be a voice communication session (e.g., telephone call) between the particular user 214 and the particular customer 210. For instance, when the interaction device 240-2 is a landline or mobile telephone (e.g., wireless communication device such as a smartphone), the particular customer 210 can dial a number that connects the particular customer 210 to a call center, and the particular customer 210 can input identifying information (e.g., name, password, account number, pin number, social security number, social media handle) via a keypad or voice that identifies the particular customer 210.

In another embodiment, the communication session can be a computer-facilitated communication session between the particular user 214 and the particular customer 210. For instance, in an implementation where the interaction device 240-2 is a desktop, laptop, wireless communication device such as a smartphone or tablet, the particular customer 210 can input identifying information at a web-site of the enterprise to request a web-based chat session with a user. The identifying information identifies the particular customer 210. When the request for interaction from a particular customer 210 is received, a particular one of the users can accept or answer that request, and the particular customer 210 is connected to that particular user and can being interacting with that particular user. In this example it is assumed that the particular user 214 that is illustrated in FIG. 2 is the user who accepted the request (to interact from the particular customer 210), but it could be any user within the enterprise.

Automatic Modification of Access Privileges at Server Response to Indication of Interaction Between Customer and User

The particular user's 214 acceptance of the request triggers an event. This event is received or heard by a listener (e.g., a server component, or a browser JavaScript component listening for these events). The listener can then notify the enterprise server 202 that the particular user 214 has accepted the particular customer's 210 request to interact. When the particular user 214 accepts or answers the request (to interact with that particular customer 210), the enterprise server 202 can receive an indication that the particular user 214 has accepted that particular customer's 210 request to interact with a user of the enterprise. For example, depending on the implementation, any number of events can trigger a communication (e.g., signal or message) to the enterprise server 202 that indicates that the particular customer 210 has requested interaction with a particular user 214 of the enterprise, or that indicates that the particular customer 210 is interacting with (or is about to being interacting with) this particular user 214 of the enterprise, and that a particular user 214 will need temporary access privileges to access the restricted customer data that is associated with that particular customer 210.

In one embodiment, the enterprise server 202 can receive information from the interaction device 240-2 associated with the particular customer 210. This information can include, for example, at least one identifier for the particular customer 210, and information that indicates that the particular customer 210 has requested interaction. Based on the identifier for the particular customer 210, the enterprise server 202 can then determine which particular user has accepted the request, and which customer data (stored in the enterprise database 230) corresponds to the restricted customer data 238 for that particular customer 210 (or is associated with that particular customer 210). This information allows the enterprise server 202 to determine which particular representative needs to have their access privileges changed or modified so that a particular enterprise computer 240-1 that the particular user 214 is currently logged into the enterprise server 202 with has appropriate access privileges to access the restricted customer data 238.

In accordance with the disclosed embodiments, the enterprise server 202 can automatically (and temporarily) modify/change access privileges associated with the restricted customer data 238 such that the computer 240-1 of the particular user 214 is given access to the restricted customer data 238 while interacting with the particular customer 210. In one embodiment, an event-based sharing application 204 implemented at enterprise server 202 controls user access privileges to data stored in the enterprise database 230 including the restricted customer data 238. The event-based sharing application 204 can automatically modify access privileges associated with the restricted customer data 238 when the enterprise server 202 receives an indication that an event has occurred (that indicates a request for interaction from a particular customer 210).

For instance, in accordance with the disclosed embodiments, when the event-based sharing application 204 receives an indication that the particular customer has sent a request to interact with a user of the enterprise and determines that the particular user 214 is the user that accepted the request, the event-based sharing application 204 can automatically modify the particular user's access privileges to allow the computer 240-1 access to the restricted customer data while the particular user 214 and the particular customer 210 are interacting. This way, when requests for restricted customer data are received from the computer 240-1 of the particular user 214, web content can be dynamically generated based on the metadata and the user access privileges and served to a browser or other client program associated with the computer 240-1 of the particular user 214.

In one non-limiting embodiment, the event-based sharing application 204 can automatically modify a data structure to grant the computer 240-1 of the particular user 214 access privileges with respect to the restricted customer data 238 for that particular customer 210. In this context, the term “automatically” means that the enterprise server 202 takes appropriate actions to modify the data structure so that the computer 240-1 of the user 214 can then be used access the restricted customer data 238 stored at the enterprise database 230 without requiring the particular user 214 to request access to modify that data structure, and without an administrator 216 having to manually change or separately configure access privileges of the particular user 214 with respect to the restricted customer data 238. In this way, the event-based sharing application 204 can temporarily modify the user's access privileges to grant the computer 240-1 of the particular user 214 permission to access to the restricted customer data 238.

In one embodiment, the event-based sharing application 204 can change a data structure of the tenant metadata 138 to control the particular user's access to the restricted customer data 238. For example, the event-based sharing application 204 can modify data within a data structure of the tenant metadata 138 to control the particular user's access to the restricted customer data 238. For instance, in one non-limiting implementation, the event-based sharing application 204 can add additional data to a data structure of the tenant metadata 138 to grant the particular user access to the restricted customer data 238.

Automatic Modification of Access Privileges at Server Response to Indication that Interaction Between Customer and User has Ended

When interaction between the particular customer 210 and particular user 214 ends, the enterprise server 202 can automatically modify the user's access privileges again to revoke access to the restricted customer data 238 by the computer 240-1 of that particular user 214. This way, the enterprise server 202 blocks that particular user's access to the restricted customer data 238. For example, in one embodiment, when the event-based sharing application 204 at the enterprise server 202 receives another indication that indicates that interaction between the particular customer 210 and the particular user 214 has ended (e.g., a message or other indication that indicates that the particular user 214 is no longer interacting with the particular customer 210), the event-based sharing application 204 can automatically modify the particular user's access privileges to prevent access to the restricted customer data so that any requests for restricted customer data that are received from the computer 240-1 of the particular user 214 will be denied due to insufficient access privileges.

In one embodiment, the enterprise server 202 can automatically modify the data structure that controls access to restricted customer data 238 to revoke/block/terminate/end that particular user's access privileges with respect to that restricted customer data 238. As a result, when the particular user's interaction with the particular customer 210 ends (e.g., end of the communication session), the computer 240-1 of the particular user 214 can no longer access the restricted customer data 238 (e.g., is then prevented from accessing the restricted customer data 238).

For example, in one non-limiting implementation, the event-based sharing application 204 can remove data from a data structure of the tenant metadata 138 to revoke the particular user's access to the restricted customer data 238.

Thus, the restricted customer data 238 is accessible by the particular user 214 during the particular user's interaction with the particular customer 210, but is inaccessible by the particular user 214 when the particular user's interaction with the particular customer 210 ends.

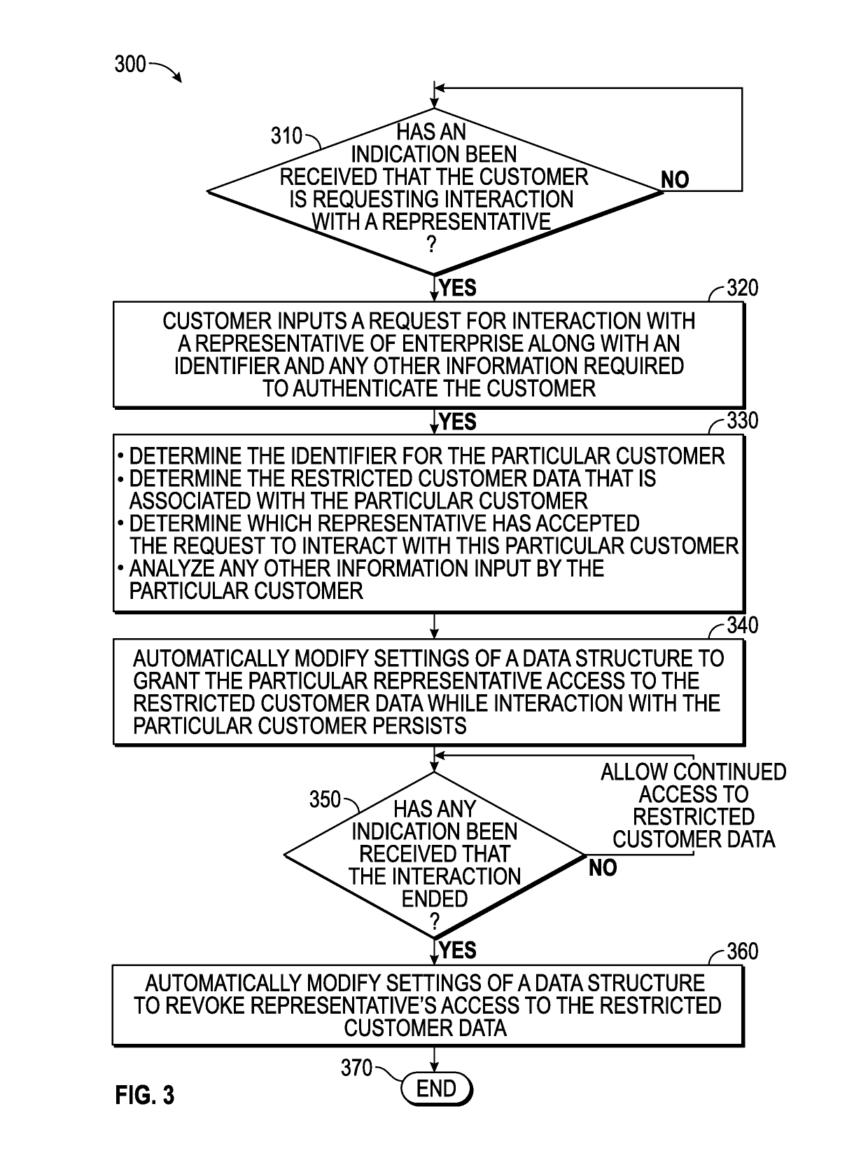

FIG. 3 is a flow chart illustrating an exemplary method 300 for controlling access to restricted customer data 238 in accordance with an embodiment. FIG. 3 will be described with reference to various elements illustrated in FIG. 2.

At step 310, the enterprise server 202 monitors incoming communications and determines whether any indication has been received that the particular customer 210 has sent a request to interact with a user of the enterprise.

Eventually, at 320, the particular customer 210 inputs information (also referred to as a customer input or request) via interaction device 240-2 that indicates that the particular customer 210 is requesting interaction with a user of the enterprise. In one embodiment, the particular customer 210 can also input an identifier that identifies the particular customer 210 and/or other information that can be used to authenticate the particular customer 210 with the enterprise server 202.

When the enterprise server 202 receives an indication that the particular customer 210 has sent a request to interact with a user of the enterprise (and other information input by the customer), the method 300 proceeds to step 330. At step 330, the enterprise server 202 determines the identifier for the particular customer 210 and the restricted customer data 238 that is associated with the particular customer 210. The enterprise server 202 also determines which user has accepted the request to interact with this particular customer 210. The enterprise server 202 can also analyze any other information input by the particular customer 210.

The method then proceeds to step 340, where the enterprise server 202 automatically modifies access privileges associated with the particular user 214 to temporarily provide the particular user 214 with access to the restricted customer data 238 for this particular customer 210 while interaction with the particular customer 210 persists. To do so, in one embodiment, the enterprise server 202 modifies settings of a data structure that is that controls access to restricted customer data 238 stored at the enterprise database 230 to grant the particular user 214 access to the restricted customer data 238. As such, the particular user 214 is automatically provided access to customer data associated with that particular customer 210 without an administrator 216 of the enterprise having to take any action to reconfigure permissions or access privileges associated with the customer data for that particular customer 210.

At step 350, the enterprise server 202 monitors incoming communications to determine whether any indication has been received that the particular user 214 is no longer interacting with the particular customer 210. The processing at 350 loops until the enterprise server 202 receives an indication that the particular user 214 is no longer interacting with the particular customer 210. This indication can be an information that indicates that a certain event has happened such as a message (or other indication) being received by the server either from the customer's interaction device 240-2 or the user's computer 240-1 (or both), or an indication that a timer has expired or that a counter has reached or exceeded a threshold at which point the method 300 automatically proceeds to step 360.

When the enterprise server 202 receives an indication that the particular user 214 is no longer interacting with the particular customer 210, the method 300 proceeds to 360, where the enterprise server 202 automatically modifies the particular user 214's access privileges to revoke access to the restricted customer data 238 by that particular user 214. To do so, the enterprise server 202 modifies settings of the data structure that controls access to restricted customer data 238 stored at the enterprise database 230 to revoke the access.

Exemplary Use Case

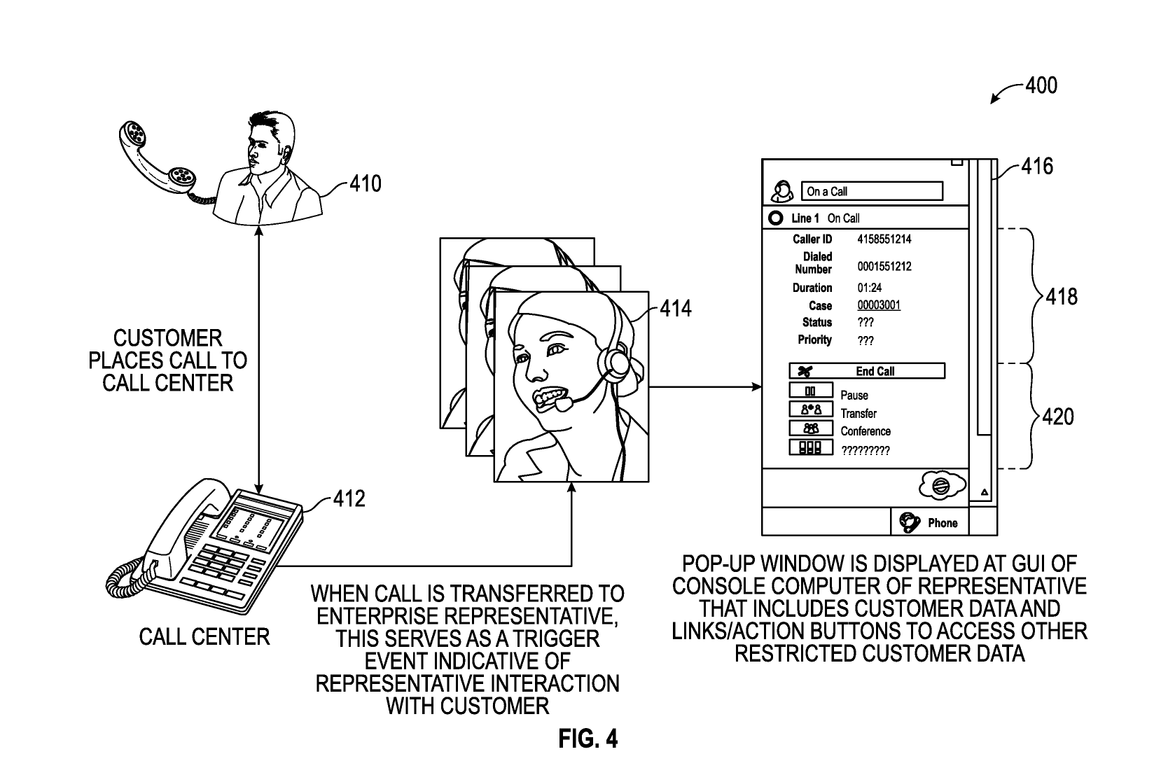

FIG. 4 is a graphical metaphor illustrating an embodiment. FIG. 4 will be described with reference to various elements illustrated in FIG. 2. In this embodiment, the interaction device 240-2 is a telephone (not labeled), and the request to interact is a request to start a voice communication session (e.g., telephone call) between the particular customer 410 (e.g., client) and a particular user 414 (e.g., call-center agent or representative) of the enterprise. The particular user 414 can be one of many representatives or agents in a call center 412 associated with the enterprise such as a bank, an investment brokerage, a health care organization, an insurance company, travel agency, public sector such as Immigration, telecommunications, media, retail such as department stores, manufacturing, logistics and transportation, etc.

In one implementation, the call center 412 can be integrated with the enterprise server 202 such that when a call comes in from the particular customer 410, the customer is prompted to enter identifying information and a request is placed in a queue for interaction with one of the users of the enterprise. In this example, a request to start the voice communication session is received at a call center 412 when the particular customer 410 places a call into the call center 412 and enters identifier information that identifies the particular customer 410. A particular user 414 will then accept this request, and the customer's call will be transferred to a particular user 414 of the enterprise so that he/she can then begin interacting with that particular customer 410. Although not illustrated, the particular user can be logged into the enterprise server using any number of different computer(s), such as consoles, tablets, laptops, wireless communication devices (e.g., iPhone™ and Android™ handsets)

When the particular user 414 accepts the request, the call is transferred to the particular user 414. This triggers an indication, communicated to the enterprise server (not illustrated in FIG. 4), that an event has occurred indicating that interaction has begun (or is about to begin). For example, a message or signal can be communicated to the enterprise server 202 that the particular customer 410 has established a communication session with a particular user 414 (i.e., started a call in this embodiment). Because the particular user 414 is logged into the enterprise server 202, an application at the server can determine which particular user 414 is interacting with a particular customer 410 and can use identifier(s) for the particular customer 410 to grant the particular user 414 access privileges with respect to customer data associated with that particular customer 410.

In this particular implementation, the enterprise server can then automatically generate web content for a graphical user interface (GUI) element 416, such as a pop-up window, a web page or a pop-up window within a web-page. The GUI element 416 can be served to a browser or other client program associated with the computer of the particular user 414. The GUI element 416 can then be displayed at a user interface of a computer (not illustrated in FIG. 4) of the particular user 414.

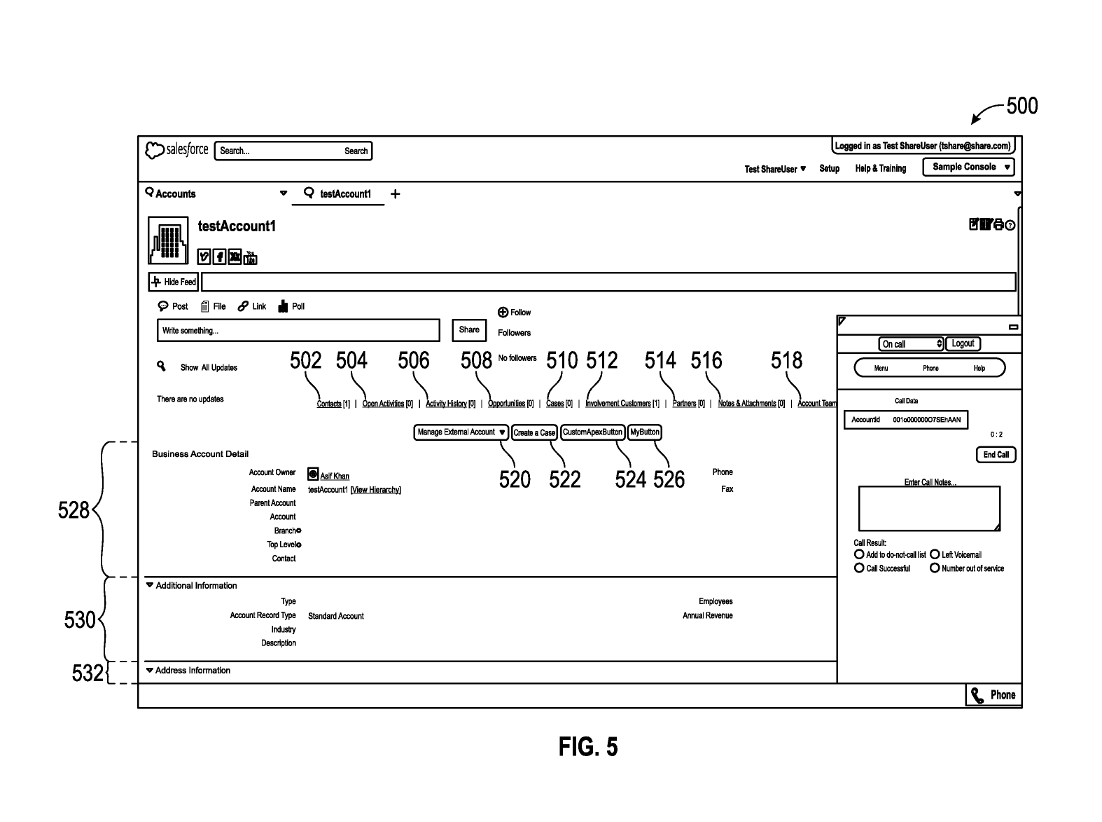

The customer data that is displayed to the user in the GUI element 416 can vary depending on the implementation. In this particular implementation, the GUI element 416 includes a section with general or primary customer data 418 (that is unrestricted this particular implementation), and another section that includes additional user interface elements 420 (e.g., links or action buttons) that the particular user 414 can interact with to access more detailed or “secondary” customer data that is always restricted customer data. If the particular user 414 wants to view more detailed customer data, the user can then interact with additional user interface elements 420 to open other web pages that allow the user to access additional restricted customer data associated with the particular customer 410. One exemplary, non-limiting implementation will be described with reference to FIG. 5.

FIG. 5 illustrates a screenshot of a web page 500 that can be displayed during interaction between a customer and a user in accordance with one exemplary implementation of an embodiment. The page 500 that can be opened in a web browser of the user when the user interacts with user interface elements 420 that are presented in the GUI element 416 illustrated in FIG. 4. This page 500 will be displayed within a browser at the user's computer so that restricted customer data 238 is displayed within the page, but only during interaction between the customer and the user. FIG. 5 includes additional links to restricted customer data 238 including contacts 502, open activities 504, activity history 506, opportunities 508, cases 510, involvement customers 512, partners 514, notes and attachments 516, and account team 518. In addition, there are action buttons to managing external account 520, create a case 522, custom apex button 524, and my button 526. The web page 500 can also include a section 528 for business account details that can include information such as the account owner, account name, parent account, access number, branch number, top-level, contact, phone number and fax number. Another section 530 of the web page also includes additional information that can be used to specify things such as type, account record type, industry, description, number of employees, and annual revenue. The web page 500 can also include a section 530 for address information, etc. There could also be numerous other types of information that not illustrated in FIG. 5 that are displayed on the page 500 including other types of restricted customer data.

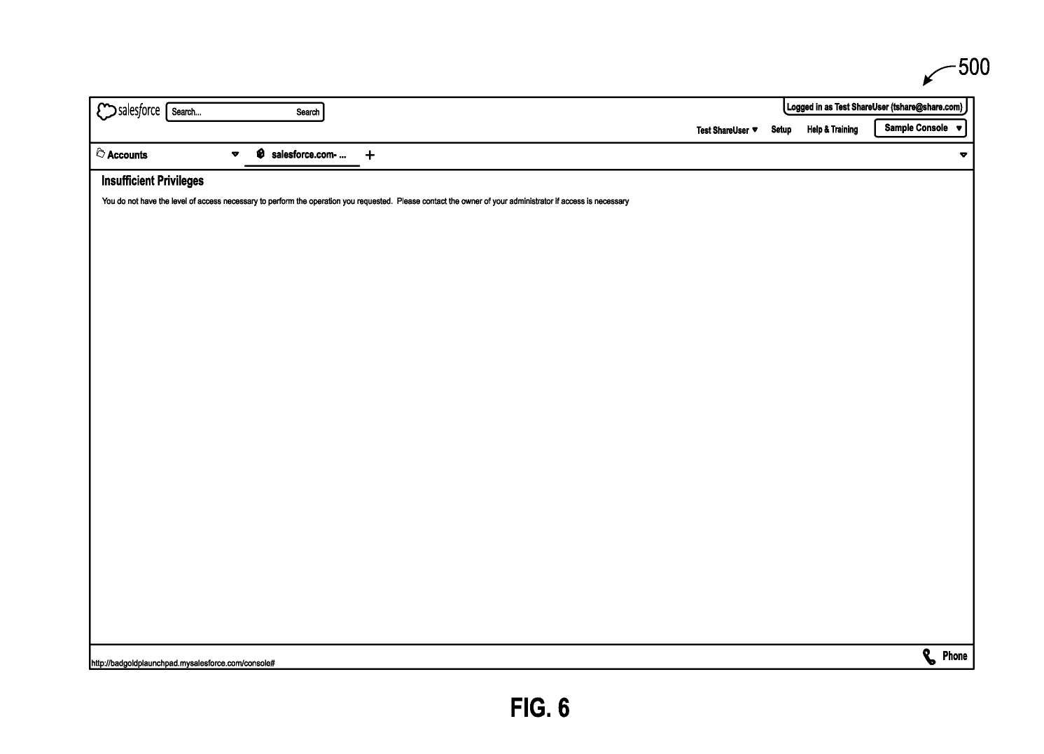

When interaction between the customer and user ends, the enterpriser server revokes the particular user's access privileges, as described above. By contrast, FIG. 6 illustrates a screenshot of a web page 600 that can be displayed when interaction between the customer and the user ends in accordance with one exemplary implementation of an embodiment. When the user attempts to access restricted customer data, the web page 600 indicates that the user has insufficient privileges to access details of the page 600. Thus, the user can access the restricted customer data 238 while interacting with the customer, but access is revoked when interaction with the customer ends so that the user no longer has access to the restricted customer data.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A computer-implemented method for controlling access to restricted customer data by a computer associated with a particular user of an enterprise while the particular user is interacting with a particular customer, wherein the restricted customer data is stored in an enterprise database and is associated with the particular customer, the computer-implemented method comprising:
monitoring, at an enterprise server, for an indication that the particular customer has sent a request to interact with a user of the enterprise;
in response to receiving the indication at the enterprise server: determining that the particular user is the user that accepted the request, and automatically modifying access privileges associated with the particular user to provide the particular user with access to the restricted customer data; and
in response to receiving, at the enterprise server, another indication that the particular user is no longer interacting with the particular customer: automatically modifying the access privileges associated with the particular user to revoke access to the restricted customer data by the particular user.

2. A computer-implemented method according to claim 1, further comprising:
inputting, via an interaction device associated with the particular customer, a customer input;
receiving, at the enterprise server, information from the computer associated with the particular customer, wherein the information comprises: the input and an identifier for the particular customer
determining, at the enterprise server based on the identifier for the particular customer, the restricted customer data that is associated with the particular customer; and
wherein the step of automatically modifying access privileges associated with the particular user to provide the particular user with access to the restricted customer data, comprises:
temporarily changing access privileges associated with the restricted customer data such that the particular user is given access to the restricted customer data while interacting with the particular customer.

3. A computer-implemented method according to claim 1, wherein the step of automatically modifying access privileges associated with the particular user to provide the particular user with access to the restricted customer data, comprises:
automatically modifying via the enterprise server, in response to receiving the indication that the event has occurred, a data structure to grant the particular user access to the restricted customer data; and
wherein the step of automatically modifying the access privileges associated with the particular user to revoke access to the restricted customer data by the particular user, comprises:
automatically modifying via the enterprise server, in response to receiving another indication that the particular user is no longer interacting with the particular customer, the data structure to revoke the access.

4. A computer-implemented method according to claim 1, wherein the request to interact is:
a request to start a communication session between the particular user and the particular customer.

5. A computer-implemented method according to claim 4, wherein the communication session is a voice communication session between the particular user and the particular customer.

6. A computer-implemented method according to claim 5, wherein the voice communication session is telephone call between the particular user and the particular customer.

7. A computer-implemented method according to claim 4, wherein the communication session is a computer-facilitated communication session between the particular user and the particular customer.

8. A computer-implemented method according to claim 1, wherein the request to interact with a user is generated in response to the particular customer interacting with a user interface of an interaction device associated with the particular customer.

9. A computer-implemented method according to claim 1, wherein the restricted customer data comprises: general customer data and proprietary customer data, and
wherein the enterprise server is further configured to: send the general customer data to the computer associated with the particular user in response to receiving the indication that the event has occurred; and
wherein the computer associated with the particular user is further configured to:
display the general customer data via a graphical user interface (GUI) element along with user interface elements that the particular user can interact with to access the proprietary customer data while the particular user and the particular customer are interacting.

10. A computer-implemented method according to claim 1, wherein the restricted customer data comprises one or more of:
transaction information regarding transactions with the customer;
sales information regarding sales with the customer;
personal information about the customer; or
any other information about the enterprise's interaction with the customer.

11. A computer-implemented system for controlling access to restricted customer data by a particular user of an enterprise while the particular user is interacting with a particular customer, comprising:
a computer associated with the particular user of the enterprise;
an enterprise database that is configured to store customer data of the enterprise, wherein the customer data comprises: restricted customer data associated with the particular customer;
an enterprise server communicatively coupled to the computer and the enterprise database, wherein the enterprise server is configured to:
monitor for an indication that the particular customer has sent a request to interact with a user of the enterprise;
determine that the particular user is the user that accepted the request to interact from the particular customer;
automatically modify, in response to receiving the indication, access privileges associated with the particular user to provide the particular user with access to the restricted customer data; and
automatically modify, in response to receiving another indication that the particular user is no longer interacting with the particular customer, the access privileges associated with the particular user to revoke access to the restricted customer data by the particular user.

12. A computer-implemented system according to claim 11, further comprising:
an interaction device associated with the particular customer that is configured to receive an input from the particular customer, and
wherein the enterprise server is configured to:
receive information from the computer associated with the particular customer, wherein the information comprises: the input and an identifier for the particular customer; and
determine, based on the identifier for the particular customer, the restricted customer data that is associated with the particular customer; and
temporarily change access privileges associated with the restricted customer data such that the particular user is given access to the restricted customer data while interacting with the particular customer.

13. A computer-implemented system according to claim 11, wherein the enterprise server is further configured to:
automatically modify, in response to receiving the indication that the event has occurred, a data structure to grant the particular user access to the restricted customer data; and
automatically modify, when the enterprise server receives another indication that the particular user is no longer interacting with the particular customer, the data structure to revoke the access.

14. A computer-implemented system according to claim 11, wherein the request to interact is:
a request to start a communication session between the particular user and the particular customer.

15. A computer-implemented system according to claim 14, wherein the communication session is a voice communication session between the particular user and the particular customer.

16. A computer-implemented system according to claim 15, wherein the voice communication session is telephone call between the particular user and the particular customer.

17. A computer-implemented system according to claim 14, wherein the communication session is a computer-facilitated communication session between the particular user and the particular customer.

18. A computer-implemented system according to claim 11, wherein the request to interact with a user is generated in response to the particular customer interacting with a user interface of an interaction device associated with the particular customer.

19. A computer-implemented system according to claim 11, wherein the restricted customer data comprises: general customer data and proprietary customer data, and
wherein the enterprise server is further configured to: send the general customer data to the computer associated with the particular user in response to receiving the indication that the event has occurred; and
wherein the computer associated with the particular user is further configured to: display the general customer data via a graphical user interface (GUI) element along with user interface elements that the particular user can interact with to access the proprietary customer data while the particular user and the particular customer are interacting.

20. A computer-readable medium having computer-executable instructions stored thereon that, when executed by a processing system of an enterprise server, cause the processing system to control access to restricted customer data stored in an enterprise database by a computer associated with a particular user of an enterprise while that particular user is interacting with a particular customer associated with the restricted customer data by:
monitoring for an indication that the particular customer has sent a request to interact with a user of the enterprise;
determining, in response to receiving the indication, that the particular user is the user of the enterprise that accepted the request;
automatically modifying, in response to receiving the indication, access privileges associated with the particular user to provide the particular user with access to the restricted customer data; and
automatically modifying, in response to receiving another indication that the particular user is no longer interacting with the particular customer, the access privileges associated with the particular user to revoke access to the restricted customer data by the particular user.
